(19) United States
(12) Patent Application Publication
(10) Pub. No.: US 2025/0310875 A1
(43) Pub. Date: Oct. 2, 2025

(54) WAKE-UP OCCASIONS FOR PLURAL-TONE, PLURAL-FREQUENCY WAKE-UP SIGNALING

(71) Applicant: Apple Inc., Cupertino, CA (US)

(72) Inventors: Francesco Negro, Munich (DE); Sharad Sambhwani, San Diego, CA (US)

(73) Assignee: Apple Inc., Cupertino, CA (US)

(21) Appl. No.: 18/864,865

(22) PCT Filed: May 11, 2023
(86) PCT No.: PCT/US2023/021920

§ 371 Date: Nov. 11, 2024

Related U.S. Application Data
(60) Provisional application No. 63/341,401, filed on May 12, 2022.

(51) Int. Cl. H04W 52/02; H04L 5/00; H04W 72/23

(52) U.S. Cl. CPC H04W 52/0216; H04L 5/0098; H04W 52/0235; H04W 72/23

(57) ABSTRACT

The present application relates to devices and components including apparatus, systems, and methods for plural-tone, plural-frequency wake-up signaling.

### CROSS-REFERENCE TO RELATED APPLICATION

This application claims the benefit of U.S. Provisional Patent Application No. 63/341,401, filed on May 12, 2022, which is hereby incorporated by reference in its entirety for all purposes.

### FIELD

This application relates to the field of wireless networks and, in particular, to wake-up occasions for plural-tone, plural-frequency wake-up signaling in such networks.

### BACKGROUND

Third Generation Partnership Project (3GPP) Technical Specifications (TSs) define standards for New Radio (NR) wireless networks. One area of study for developing these TSs is managing power consumption in user equipments (UEs). Efficient power management will allow a UE to power down inactive components and reactivate them only when needed.

### BRIEF DESCRIPTION OF THE DRAWINGS

FIG. 1 illustrates a network environment in accordance with some embodiments.

FIG. 2 illustrates a wake-up signal in accordance with some embodiments.

FIG. 3 illustrates wake-up signals in accordance with some embodiments.

FIG. 4 illustrates another network environment in accordance with some embodiments.

FIG. 5 illustrates a set of tones configured with different spacings in accordance with some embodiments.

FIG. 6 illustrates wake-up occasions in accordance with some embodiments.

FIG. 7 illustrates another network environment in accordance with some embodiments.

FIG. 8 illustrates wake-up occasions in accordance with some embodiments.

FIG. 9 illustrate tone allocations in accordance with some embodiments.

FIG. 10 illustrate additional tone allocations in accordance with some embodiments.

FIG. 11 illustrate additional tone allocations in accordance with some embodiments.

FIG. 12 illustrates a signaling sequence in accordance with some embodiments.

FIG. 13 illustrates a spectrum allocation in accordance with some embodiments.

FIG. 14 illustrates an operation flow/algorithmic structure in accordance with some embodiments.

FIG. 15 illustrates another operation flow/algorithmic structure in accordance with some embodiments.

FIG. 16 illustrates another operation flow/algorithmic structure in accordance with some embodiments.

FIG. 17 illustrates a user equipment in accordance with some embodiments.

FIG. 18 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

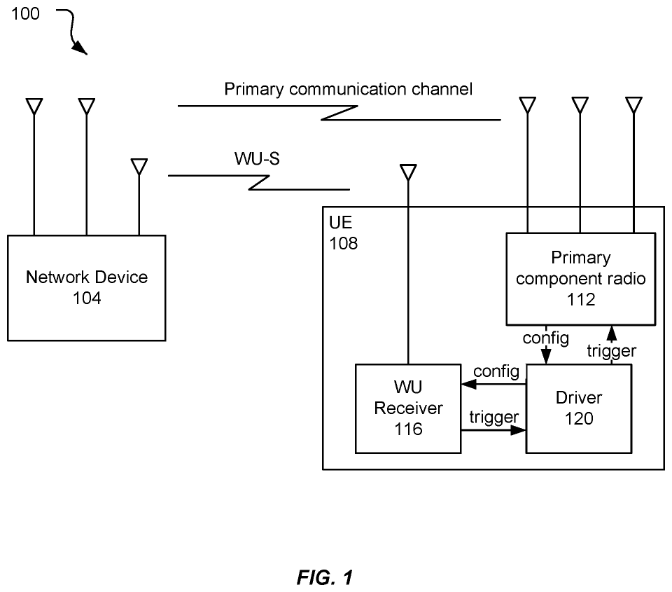

FIG. 1 illustrates a network environment 100 in accordance with some embodiments. The network environment 100 may include a network device 104 and a UE 108. In some embodiments, the network device 104 may be a base station that provides one or more wireless access cells, for example, new radio (NR) cells, through which the UE 108 may communicate with a cellular network. In other embodiments, the network device 104 may be another UE or other device in communication with the UE 108.

The UE 108 and the network device 104 may communicate over air interfaces compatible with Fifth Generation (5G) NR (or later) system standards as provided by 3GPP technical specifications. These air interfaces may be access links or sidelink interfaces.

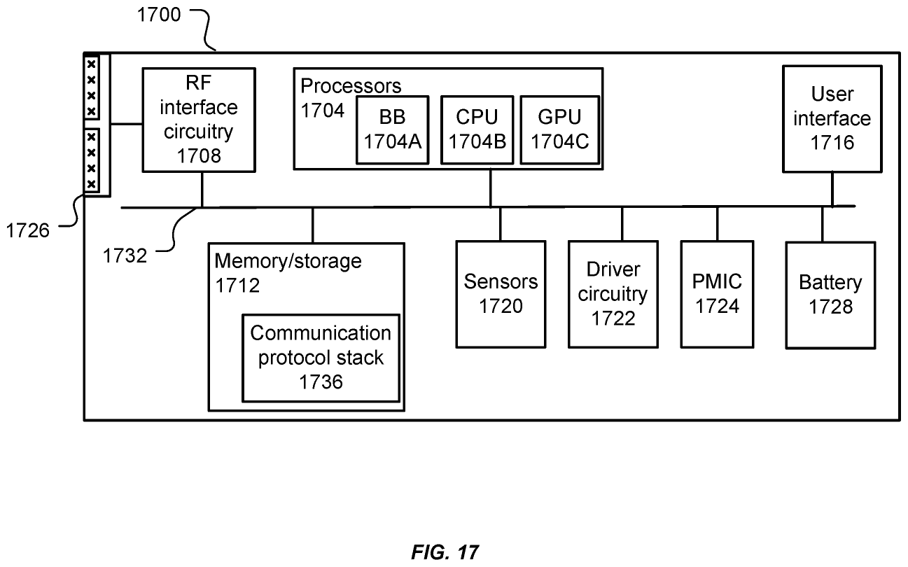

The UE 108 may include a radio resource control (RRC) state machine that perform operations related to a variety of RRC procedures including, for example, paging, RRC connection establishment, RRC connection reconfiguration, and RRC connection release. The RRC state machine may be implemented by protocol processing circuitry, see, for example, processors 1704 of FIG. 17.

The RRC state machine may transition the UE 108 into one of a number of RRC states (or “modes”) including, for example, a connected state (RRC connected), an inactive state (RRC inactive), and an idle state (RRC idle). The UE 108 may start in RRC idle when it first camps on an NR cell, which may be after the UE 108 is switched on or after an inter-system cell reselection from a Long Term Evolution (LTE) cell. To engage in active communications, the RRC state machine may transition the UE 108 from RRC idle to RRC connected by performing an RRC setup procedure to establish a logical connection, for example, an RRC connection, with a base station. In RRC connected, the UE 108 may be configured with at least one signaling radio bearer (SRB) for signaling (for example, control messages) with the base station; and one or more data radio bearers (DRBs) for data transmission. When the UE 108 is less actively engaged in network communications, the RRC state machine may transition the UE 108 from RRC connected to RRC inactive using an RRC release procedure. The RRC inactive state may allow the UE 108 to reduce power consumption as compared to RRC connected, but will still allow the UE 108 to quickly transition back to RRC connected to transfer application data or signaling messages.

A network may transmit paging messages in order to reach UEs that are in RRC idle or RRC inactive states. In operation, much of the time the UE 108 is powered on, it will be in an idle or inactive state. During these states, the UE 108 may expend a significant amount of power to periodically monitor for paging messages, which may rarely be detected. Thus, embodiments describe processes to increase the amount of time the UE 108 may keep its primary components in a reduced-power state and still be available, as needed, to timely receive messages from the network.

The UE 108 may include a primary component radio 112 that includes radio-frequency (RF) and modulator/demodulator components configured to perform primary receive and transmit operations in the course of communicating with the network device 104. Some of these receive/transmit operations are discussed in more detail with respect to UE 1700 of FIG. 17. The UE 108 may also include a wake-up (WU) receiver 116. The WU receiver 116 may be a relatively low-complexity receiver that is designed to specifically detect a WU-signal (WU-S) transmitted by the network device 104. The UE 108 may further include a driver 120 coupled with the primary component radio 112 and the WU receiver 116.

In operation, the primary component radio 112 may receive configuration information from the network device 104 via a primary communication channel. In some embodiments, the configuration information may be exchanged as part of a WU configuration protocol between the UE 108 and the network device 104. This configuration protocol may include an exchange of WU signaling settings. For example, the UE 108 may use the primary component radio 112 to transmit WU capability information about the UE 108. The capability information may include details of the operating capacity of the WU receiver 116. In response, the network device 104 may provide configuration information, including WU-S parameters to the UE 108. The UE 108 may receive the configuration information using the primary component radio 112.

The driver 120 may receive the configuration information from the primary component radio 112 and provide the configuration information to the WU receiver 116. In this manner, the WU receiver 116 may be configured with the WU-S parameters to facilitate detection of the WU-S transmitted by the network device 104.

Providing the configuration parameters to the primary component radio 112, as opposed to relying on an over-the-air configuration between the WU receiver 116 may allow a low-complexity design of the WU receiver 116.

When not engaged in receiving communications from the network device 104, the primary component radio 112 may transition to a reduced-power state and the UE 108 may activate the WU receiver 116. Upon detecting the WU-S, the WU receiver 116 may provide a trigger to the driver 120. The driver 120 may provide the trigger to the primary component radio 112 as a wake-up indication. The primary component radio 112 may then power up to receive a paging message via the primary communication channel and the WU receiver 116 may power down.

In the event the network device 104 needs to update the WU configurations of the UE 108 while the primary component radio 112 is in a reduced-power state, the UE 108 may send a WU-S to the WU receiver 116 to activate the primary component radio 112. The network device 104 and the UE 108 may engage in the WU configuration protocol as described above once the primary component radio 112 is activated.

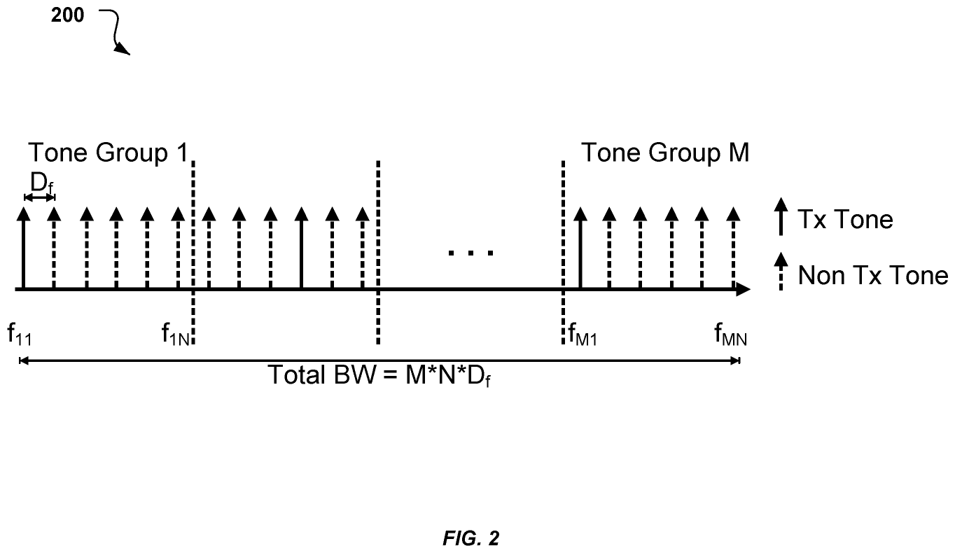

FIG. 2 illustrates a WU-S 200 in accordance with some embodiments. The WU-S 200 may be a plural-tone, plural-frequency (PTPF) WU-S that is assigned to the UE 108. In some embodiments, the WU-S 200 may be assigned exclusively to the UE 108. In this case, the WU-S 200 may be used to wake-up components of the UE 108 and no other UEs. In other embodiments, the WU-S 200 may be assigned to a group of UEs and may be used to wake-up components on the group.

The WU-S 200 may include tones selected from M tone groups. Each tone group may have N tones. The tones may be distributed throughout a total WU-S bandwidth that is equal to M*N*D_{f}, where D_{f} is a distance between adjacent tones of the WU-S bandwidth.

A tone, as used herein, may refer to a specific frequency. If the network device 104 provides energy on a tone, it may be referred to as a transmit (Tx) tone. If the network device 104 does not provide energy on a tone, it may be referred to as a non-Tx tone. If the network device 104 has a primary transmitter that uses orthogonal frequency division multiplexing (OFDM), the network device 104 may use the primary transmitter to generate the WU-S 200. In some embodiments, the network device 104 may have a dedicated transmitter to generate the WU-S 200.

As shown in FIG. 2, the WU-S 200 may have Tx tones corresponding to the first tone of tone group 1, the fourth tone of tone group 2, and the first tone of tone group M. The Tx tones selected for a given WU-S may be uniformly or non-uniformly spaced according to network availability.

In some embodiments, each device of a network may be configured with a unique WU sequence of M tones (for example, one tone per tone group). This configuration may be communicated to a WU device through the WU-S configuration parameters received via a primary component radio. When a first UE (UE1) has a receiver of its primary component radio power down, its WU receiver may monitor a first sequence, (f₁^{UE1}, f₂^{UE1}, . . . f_{M}^{UE1}); and when a second UE (UE2) has a receiver of its primary component radio power down, its WU receiver may monitor a second sequence, (f₁^{UE1}, f₂^{UE2}, . . . f_{M}^{UE2}).

The WU receivers may use various algorithms to detect the WU-S based on a respective WU sequence. For example, a WU receiver may have a digital signal processor (DSP) to implement a Goertzel algorithm to evaluate individual terms a discrete Fourier transform (DFT) in order to detect a PTPF WU-S over a known set of M frequencies. In some embodiments, the WU receiver may have a set of M tunable filters in the appropriate frequencies that may be used to detect the Tx tones of a PTPF WU-S that matches a configured WU sequence.

Dividing the WU-S bandwidth into the tone groups as shown in FIG. 2 may provide a number of advantages. For example, uniquely addressing 1024 devices with a single tone would require 1024 tones. However, use of the grouped described above may provide the potential to address N^{tM} devices. For example, using 24 total tones divided into four groups (M=4) with six tones in each group (N=6) will enable a network to uniquely address 1296 devices (6⁴=1296). Thus, the network may be provided with more freedom to divide the available tones according to needs.

Distributing the tones across the bandwidth may also allow frequency diversity to be exploited.

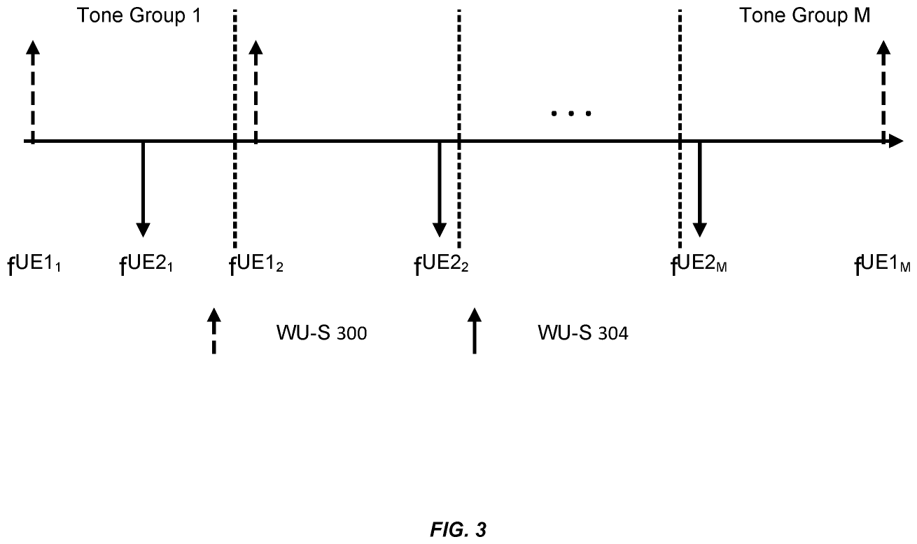

FIG. 3 illustrates WU signals 300 and 304 in accordance with some embodiments. In some embodiments, the Tx tones may also be modulated by a code, with each device being identified by a tone sequence and a binary code. For example, if UE1 is provided with a binary code of (1, 1, . . . , 1) and UE2 is provided with a binary code of (−1, −1, . . . −1), their respective WU sequences may be modulated to be UE1: (f₁^{UE1}, f₂^{UE1}, . . . f_{M}^{UE1}) and UE2: (−f₁^{UE1}, −f₂^{UE2}, . . . f_{M}^{UE2}).

WU-S 300, which may correspond to modulated WU sequence for UE1, may be represented by: A*cos(2πf₁^{UE1}*n)+A*cos(2πf₂^{UE1}*n)+ . . . +A*cos(2πf_{M}^{UE1}*n), where A is an amplitude of the Tx tone.

WU-S 304, which may correspond to modulated WU sequence for UE2, may be represented by: (−1)*A*cos(2πf₁^{UE2}*n)+(−1)*A*cos(2πf₂^{UE2}*n)+ . . . +(−1)*A*cos(2πf_{M}^{UE2}*n). Thus, the amplitude of each Tx tone of the WU-S 304 is inverted.

In this manner, the number of served devices may be increased by 2^{M}.

In addition to providing the opportunity to uniquely identify more devices, a modulated WU-S may be more robust against receiver or channel impairments such as, for example, carrier frequency offset or Doppler fading effects.

While the above embodiments shows the applied binary code as all positive ones or all negative ones, other embodiments may use binary codes having a mix of positive and negative ones.

In the above embodiments, each device was provided with a WU sequence having the same number of Tx tones. However, in some embodiments, a length of the PTPF WU sequences assigned to the various devices of a network may be based a coverage area of the respective device. In this way, the coded PTPF WU signals may help to efficiently multiplex devices in different coverage area.

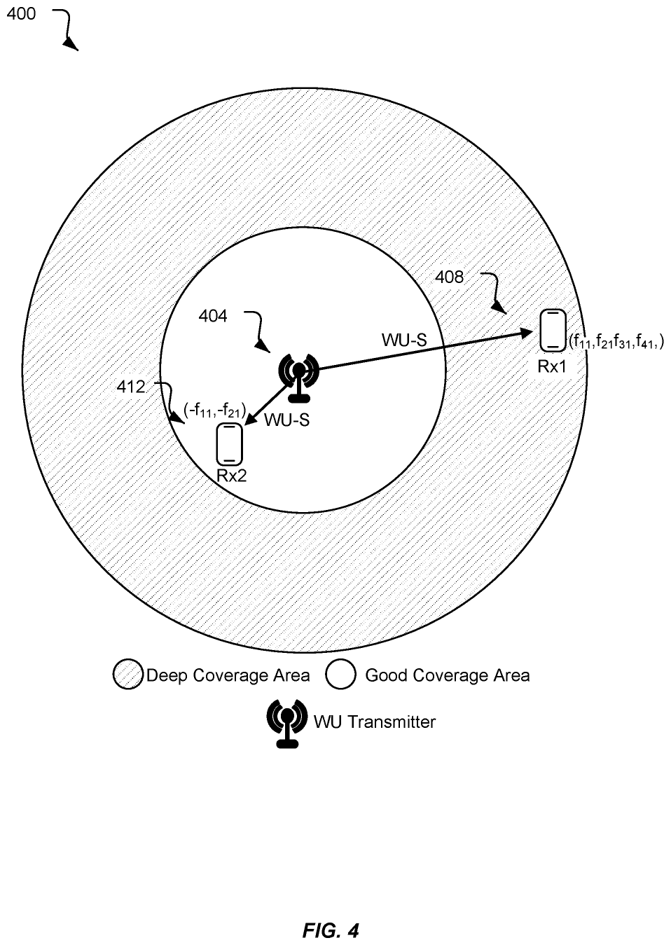

FIG. 4 illustrates a network environment 400 in accordance with some embodiments. The network environment 400 may include a WU transmitter 404 providing first cellular coverage for a first UE 408 and a second UE 412. The WU transmitter 404 may be a base station or another transmitting device. The first UE 408 may be in a deep coverage area of the cell (for example, at an edge of the cell), while the UE 412 may be in good coverage area (relative to the deep coverage area).

The network may determine the respective coverage areas of the UE 408 and UE 412 based on measurement reports. The measurement reports may be based on reference signal receive power (RSRP) measurements, reference signal strength indicator (RSSI) measurements, etc. The network may obtain the measurement reports from primary component radios of the respective devices.

Based on the UE 408 being in the deep coverage area, the network may decide to allocate a set of four tones to the UE 408, (f₁₁, f₂₁, f₃₁, f₄₁). Providing more tones may allow the UE 408 to apply some energy combining techniques to increase the chance that the summed energy is above a defined threshold that would determine correct detection of a WU signal.

Based on the UE 412 being in the good coverage area, the network may decide to allocate a set of two tones to the UE 412, (−f₁₁, −f₂₁). Being in the good coverage area, the UE 412 may be able to correctly decode the two-tone sequence.

In some embodiments, the WU transmitter 404 may send WU signals to both UE 408 and 412 at the same time by transmitting a WU signal with a sequence of (−f₁₁, −f₂₁, f₃₁, f₄₁). Such a signal may be correctly interpreted by both UEs.

The above-described operations of the network may be performed by a base station. The base station may include the WU transmitter 404 or may be separate from the WU transmitter 404.

While FIG. 4 describes selection of WU sequences based on coverage areas, other embodiments may base tone spacing selection and modulation on coverage areas.

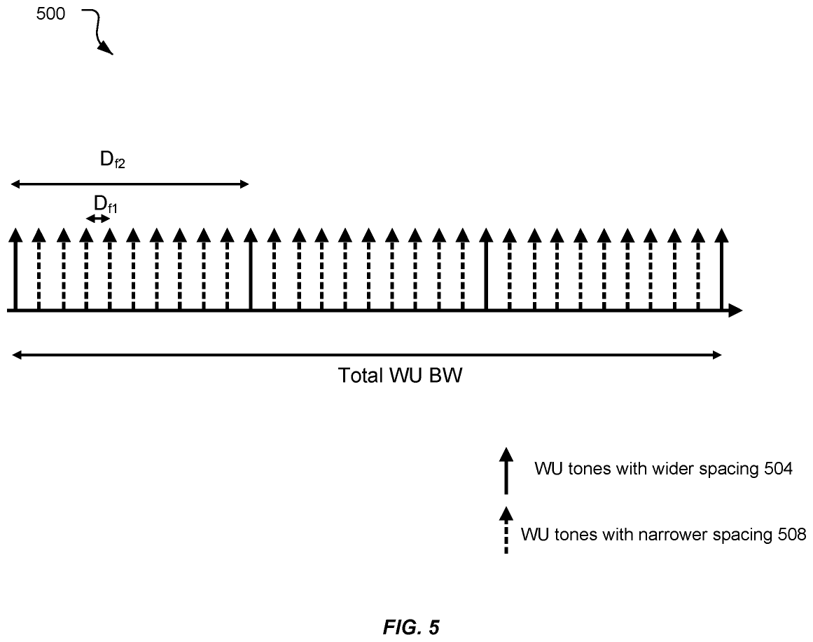

FIG. 5 illustrates sets of tones 500 configured with different spacings in accordance with some embodiments. The sets of tones 500 may include a first set of WU tones with a wider spacing 504 and a second set of WU tones with a narrower spacing 508. In some embodiments, the first set of WU tones with a wider spacing 504 may be interleaved with the second set of WU tones with a narrower spacing 508 as shown. In other embodiments, the first set of WU tones with a wider spacing 504 may be assigned to a first set of frequencies and the second set of WU tones with a narrower spacing 508 may be assigned with a second set of frequencies, where the first and second set of frequencies do not overlap.

The network may decide which tone spacing to allocate based on receiver device link quality. Additionally/alternatively, the network may determine whether to use per-tone modulation based on the receiver device link quality. The primary component radio 112, while active, may report a set of measurements (e.g., RSSI) to the network device 104 to help the network device 104 properly design the WU signaling.

The network device 104 may decide to use the second set of tones with narrower spacing 508 for devices that are characterized by a good link quality and apply a per-tone modulation. Since the link budget may be favorable for these devices, they may be able to correctly detect the transmitted set of tones and the corresponding transmitted sequence.

The network device 104 may decide to use the second set of tones with wider spacing 504 for devices that are characterized by a poorer link quality and may not apply a per-tone modulation. A tone allocation with wider tone spacing may be more resilient to channel impairments, e.g., Doppler effects, frequency offset, and interference.

In some embodiments, the second set of tones with the narrower spacing 508 may be used by local networks or sub-networks that are characterized by more favorable channel conditions. These types of networks may include, for example, peer-to-peer networks and wireless sensor networks. Devices within such networks may have better link quality and very static behavior that may not involve mobility within cells of the same tracking area.

As briefly discussed above, a majority of the time a UE is powered on, it may be in a reduced-power mode such as, for example, an idle mode. While in the idle mode, the UE may move from cell to cell. Challenges may be presented when a network is to serve a large number of these devices as they move between cells of tracking area. A solution based only on incrementing the number of tones used by the WU system could lead to a significant increase of resources dedicated to send WU signaling, which may reduce the practicality of system. Thus, some embodiments provide a scalable WU system that allows a network to individually address a large number of devices that may move among cells of a cellular tracking area while in an idle mode. This may be done by multiplexing devices in various time instances called WU occasions (WU-Os).

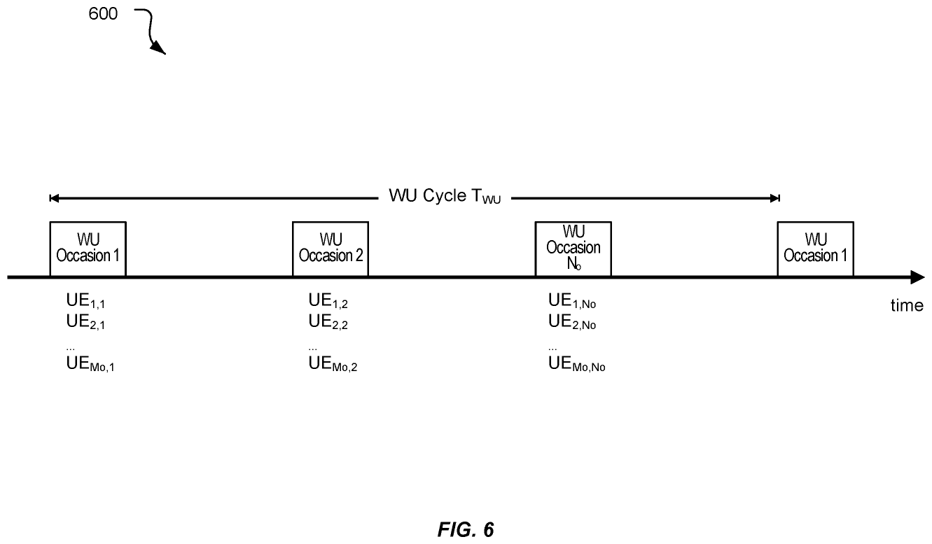

FIG. 6 illustrates WU-Os 600 in accordance with some embodiments. In particular, the WU-Os 600 include N_{O} WU occasions and are associated with a WU-cycle having a length of T_{WU}. Different UEs may be multiplexed in different WU-Os. For example, a UE may be associated with both a WU sequence and one or more WU-Os. The UE will then try to detect WU signals corresponding to the assigned WU sequence within the assigned WU-Os. The WU-O assignments may be on a device-by-device basis.

The N_{O} WU-Os of FIG. 6 are shown as equally spaced within the WU-Cycle; however, in other embodiments, other spacings may be used. In each WU-O, up to Mo devices may be active to detect their WU-Ss. The WU-Os assigned to a device may be based on a device ID, a priority class, or latency requirements. For example, a latency-sensitive device may be assigned with more WU-Os to monitor as compared to a latency-insensitive device. This may allow the latency-sensitive device to more quickly detect a WU-S and reactivate the primary receiver for receipt of the paging message.

In some embodiments, the WU-receiver may power down in between WU-Os that it is assigned to monitor. This may increase power savings in situations in which the WU receiver has sufficient time to both power down and power up before monitoring the next WU-O for an assigned WU-S.

The WU-Os that a device is assigned to monitor may be included in the WU parameters of the configuration information provided to the primary receiver as described above. The WU-Os may be assigned to the device for all cells of a tracking area.

In some embodiments, the WU sequence a device is to detect may be the same sequence throughout all of the WU-Os assigned to the device. In other embodiments, the WU sequence may change from WU-O to WU-O.

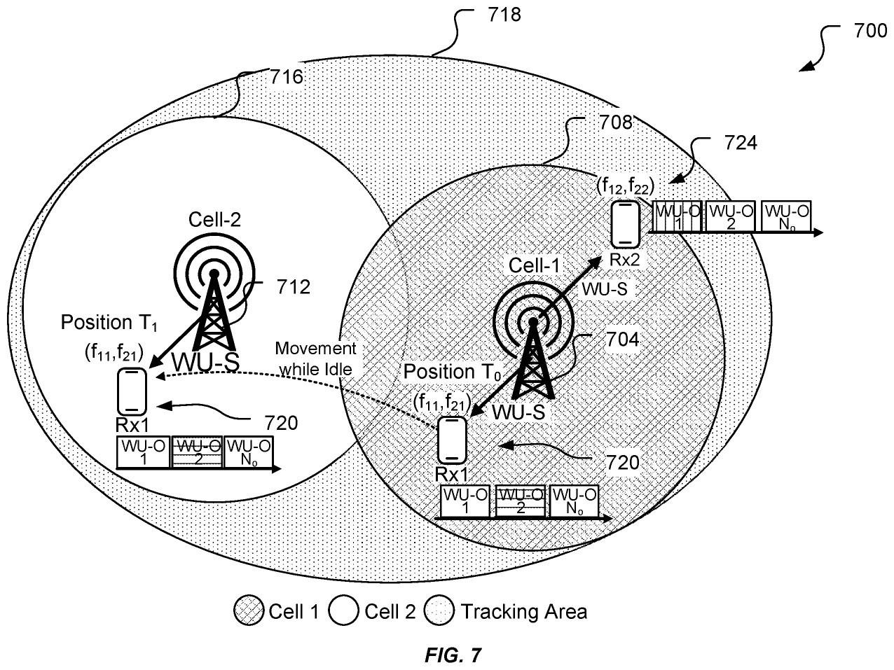

FIG. 7 illustrates a network environment 700 in accordance with some embodiments. The network environment may include a base station 704 that provides a cell 708 and a base station 712 that provides a cell 716. Both cells 708 and 716 may belong to tracking area 718. The network environment 700 may further include a UE 720 and a UE 724.

The UEs 720 and 724 may be configured with WU parameters that apply to all the cells of the tracking area 718. In particular, the UE 720 may be assigned a WU sequence (f₁₁, f₂₁) to monitor in a second WU-O (WU-O 2); and the UE 724 may be assigned a WU sequence (f₁₂, f₂₂) to monitor in a first WU-O (WU-O 1).

At a first time instance (T₀) the UE 720 may be in position T₀ within the cell 708. While in an idle mode, the UE 720 may move to a position T₁ in cell 716 at a second time instance (T₁). The UE 720 may continue to monitor the WU-O 2 for the WU sequence (f₁₁, f₂₁) as the WU parameters configured for cell 708 may also apply to cell 716. Thus, the WU reception procedures may not change as the UE 720 moves among cells of the tracking area 718. In this manner, the UE 720 may be reachable throughout cells of the tracking area 718 without increasing receiver complexity.

In some embodiments, the network may initially send a wake-up signal in a last cell in which a UE was registered. For example, if the UE 720 transitions to an idle mode while in cell 708, the network may initially transmit the wake-up signal in that cell. If the UE 720 does not respond, the network may transmit the wake-up signals in the other cells of the tracking area 718, for example, cell 716.

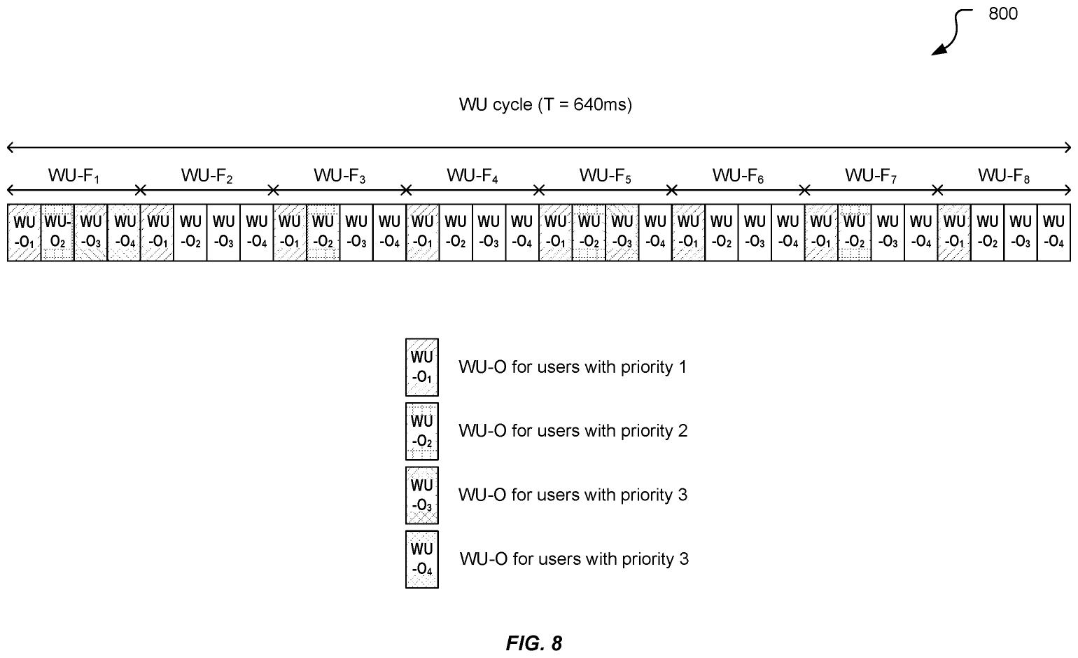

FIG. 8 illustrates WU-Os 800 in accordance with some embodiments. The WU-Os 800 may be arranged in WU-frames (WU-Fs). The WU-Fs may facilitate flexibility of assigning different devices a desired number of WU-Os to monitor in a WU-cycle.

As shown, a WU-cycle may have a length (I) equal to 64 frames (or 640 milliseconds), similar to a length of a discontinuous reception (DRX) cycle. The number of WU-Fs in each WU cycle (N_{WU-F}) may be set to T/8=8. The number of WU-Os in each WU-F (N_{WU-O}) may be set to four.

If a maximum number of devices that can be uniquely addressed in a WU-O is 32, then a total number of devices that can be uniquely addressed in a WU cycle may be equal to 32×4×8=1024.

In each WU-O, at least 32 devices may be uniquely addressed if, for example, the number of tones per group (N) is greater than or equal to 32. For example, this may happen with a numerology as follows: M=2, N=32, Df=120 kHz and a total BW is approximately 7.6 MHz.

The WU-O allocations may be based on a device priority. Assuming the numerology, the following allocations may be made in some embodiments:
Priority-1 Device: one WU-O every WU-F→latency 80 milliseconds (32 devices);
Priority-2 Device: one WU-O every two WU-Fs→latency 160 milliseconds (32 devices);
Priority-4 Device: one WU-O every four WU-Fs→latency 320 milliseconds (32 devices);
Priority-8 Device: one WU-O every eight WU-Fs→latency 640 milliseconds (18*32=576 devices).

As can be seen in FIG. 8, a priority-1 device assigned to monitor WU-O₁, may monitor that WU-O in every WU-F, a priority-2 device assigned to monitor WU-O₂, may monitor that WU-O in every other WU-F, a priority-4 device assigned to monitor WU-O₃, may monitor that WU-O in every fourth WU-F, and a priority-8 device assigned to monitor WU-O₄, may monitor that WU-O in only one WU-F.

If all symbols in a WU cycle (T=64 frames) are used for WU signals, then

$$14 * 10 * 64 \frac{WU occasions}{WU frame} = 8 , 960 WU occasions .$$

In some embodiments, the PTPF WU signaling may be used to efficiently share resources among a number of transmitting devices.

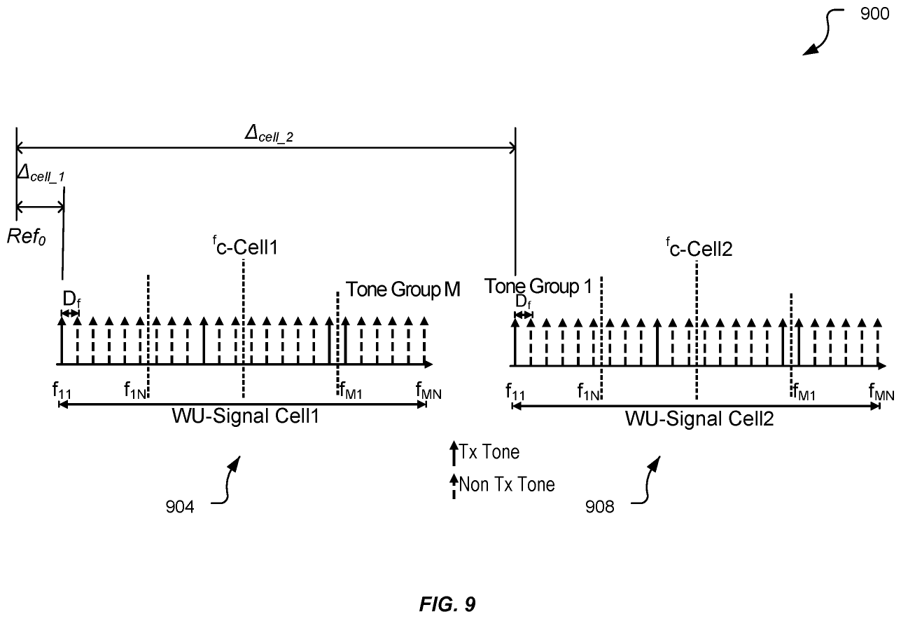

FIG. 9 illustrates tone allocations 900 in accordance with some embodiments. The tone allocations 900 may include a first set of tones 904 and a second set of tones 908. The first set of tones 904 may be used for WU signals in a first cell, while the second set of tones 908 may be used for WU signals in a second cell. The first set of tones 904 may be offset from a system reference (Ref₀) by a first offset value (Δ_{cell_1}) and the second set of tones 908 may be offset from a system reference (Ref₀) by a second offset value (Δ_{cell_2}). As shown, the first and second offset values may cause the sets of tones to be completely non-overlapping with one another.

The offset values are shown to offset a first tone of a set of tones from the system reference; however, in other embodiments, the offset may be relative to a center frequency (f_{C}) of the set of tones.

The system reference (Ref₀) may correspond to an initial subset of frequencies that is common to all transmitters. The offset values may correspond to cell-specific frequency shifts. For example, the first offset value (Δ_{cell_1}) may be a function of an identity of a transmitter of the first cell and the offset value (Δ_{cell_2}) may be a function of an identity of a transmitter of the second cell. Thus, the set of tones assigned to UEᵢ in cellⱼ may be provided as:

$${UE}_{i}^{{Cell}_{j}} = \{ ( {f}_{i 1} , {f}_{i 2} , … , {f}_{i M} ) ; Δ {Cell}_{j} \} .$$

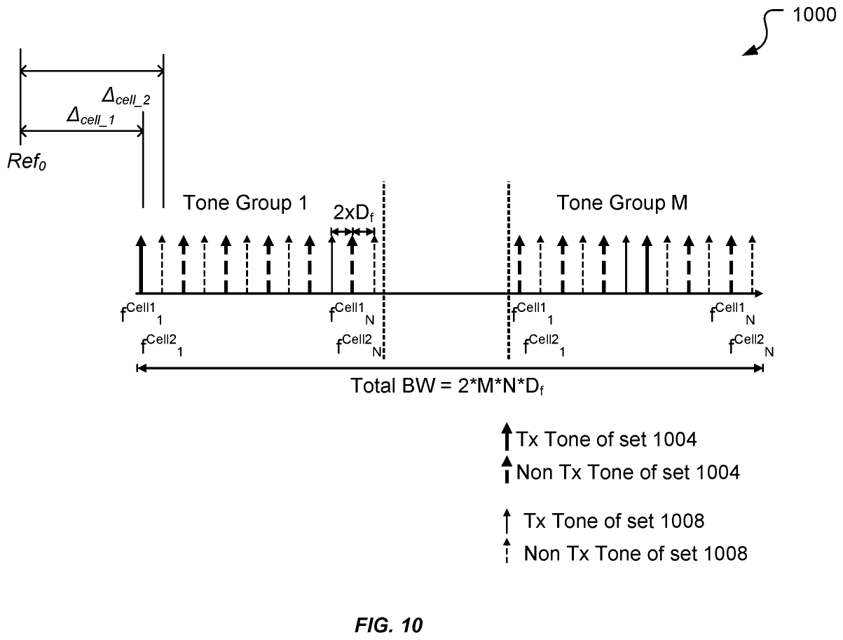

FIG. 10 illustrates tone allocations 1000 in accordance with some embodiments. The tone allocations 1000 may include a first set of tones 1004 and a second set of tones 1008. The first set of tones 1004 may be used for WU signals in a first cell, while the second set of tones 1008 may be used for WU signals in a second cell. The first set of tones 1004 may be offset from a system reference (Ref₀) by a first offset value (Δ_{cell_1}) and the second set of tones 1008 may be offset from a system reference (Ref₀) by a second offset value (Δ_{cell_2}). As shown, the first and second offset values may cause the sets of tones to overlap one another such that the second set of tones 1008 are interleaved with the first set of tones 1004. The offset values and spacing of the tones may be set in a manner to preserve orthogonality.

The spacing between adjacent tones, which will be of different sets, may be D_{f}. Thus, spacing between tones of the same set may be 2*D_{f}. The total bandwidth may be equal to 2*M*N*D_{f}.

In all other manners, the assignment and use of the tone allocations 1000 may be similar that described above with respect to tone allocations 900.

Some embodiments may use a transmitter-specific signature in the transmission of PTPF wake-up signals. For example, the configuration parameters may include a cell-specific signature. A UE may use the cell-specific signature to modulate its WU sequence to determine a modulated WU sequence that should be monitored for a particular cell. For example, UEᵢ in cellⱼ may be configured with

$${UE}_{i}^{{Cell}_{j}} = \{ ( {α}_{1 , j} {f}_{i 1} , {α}_{1 , j} {f}_{i 1} , … , {α}_{M , j} {f}_{i M} ) ; {\{ {α}_{n , j} \}}_{n = 1 : M} {Cell}_{j} Specific signature \} .$$

While some of the embodiments discussed herein describe using the wake-up system to enable the primary component radio 112 to power-down to an idle or inactive mode, embodiments also apply to the primary component radio 112 powering down within a connected mode. For example, the UE 108 may perform a connected-DRX (C-DRX) operation by cycling between a DRX-ON phase, in which the primary component radio 112 is powered on to monitor a physical downlink control channel (PDCCH) of the primary communication channel, and a DRX-OFF phase in which the primary component radio 112 is powered-down. Throughout the C-DRX operation, the UE 108 may remain in the RRC connected mode. Some embodiments may transition the UE 108 in C-DRX to a deeper power saving mode by activating the WU receiver 116 and reducing the functionality of the primary component radio 112 to reduce power. While in the deeper power saving mode, the UE 108 may skip powering up the primary component radio 112 for one or more DRX-ON phases. If the network device 104 has data to transmit to the UE 108, it may send a wake-up signal to the WU receiver 116 and the UE 108 may power-on the primary component radio 112 as described elsewhere herein. The primary component radio 112 may then monitor for the subsequent PDCCH transmitted by the network device 104.

In various embodiments, the WU occasions concepts described herein may also be used with DRX operation.

In some embodiments, the configuration information provided to the UE 108 may include one or more frequency hopping patterns. These patterns may be used to dynamically change the sets of frequencies associated to tones allocated to the UE 108. The hopping may take place within tones of a same set or in different sets. The frequency hopping patterns may allow the system to adapt to different network load or privacy considerations given that the configured frequency hopping patterns may be specific to a particular device and known only to the transmitter and receiver.

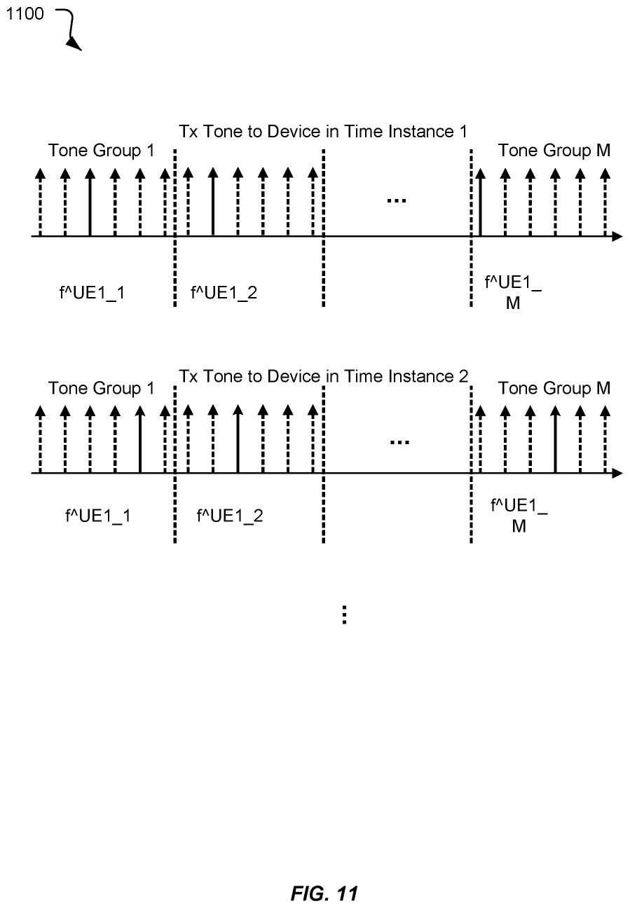

FIG. 11 illustrates tone allocations 1100 using a frequency hopping pattern across a plurality of time instances in accordance with some embodiments.

In this embodiments, the UE 108 may be assigned with a FH pattern of (2, 1, . . . 3) that increases a Tx tone in group 1 by two, increases a Tx tone in group 2 by one, and increases a Tx tone in group M by 3. Thus, in time instance 1, the UE 108 may be assigned a WU sequence with Tx tone 3 in group 1, Tx tone 2 in group 2, and Tx tone 1 in group M. In the next time instance 2, the UE 108 may monitor for a WU signal that matches a WU sequence with Tx tone 5 in group 1, Tx tone 3 in group 2, and Tx tone 4 in group M. The hopping may proceed in this manner through any number of time instances.

In other embodiments, other frequency hopping patterns may be used. For example, in some embodiments, a FH pattern may indicate one hopping value that may increment through different tone groups. If the hopping value is 1, a Tx tone of the first tone group may increment in a first time instance, a Tx tone of a second tone group may increment in a second time instance, and so on.

In some embodiments, instead of using the FH pattern to modify the WU sequence that is monitored in different time instances, a common WU sequence may be monitored in different sets of frequencies in different time instances. For example, in a first time instance the UE may monitor a first set of frequencies for a WU sequence with Tx tone 3 in group 1, Tx tone 2 in group 2, and Tx tone 1 in group M; and in a second time instance the UE may monitor a second set of frequencies (offset from the first set of frequencies) for the same WU sequence.

In some embodiments, frequency hopping may be used in conjunction with repetition to enhance coverage and increase robustness of the wake-up signal transmission.

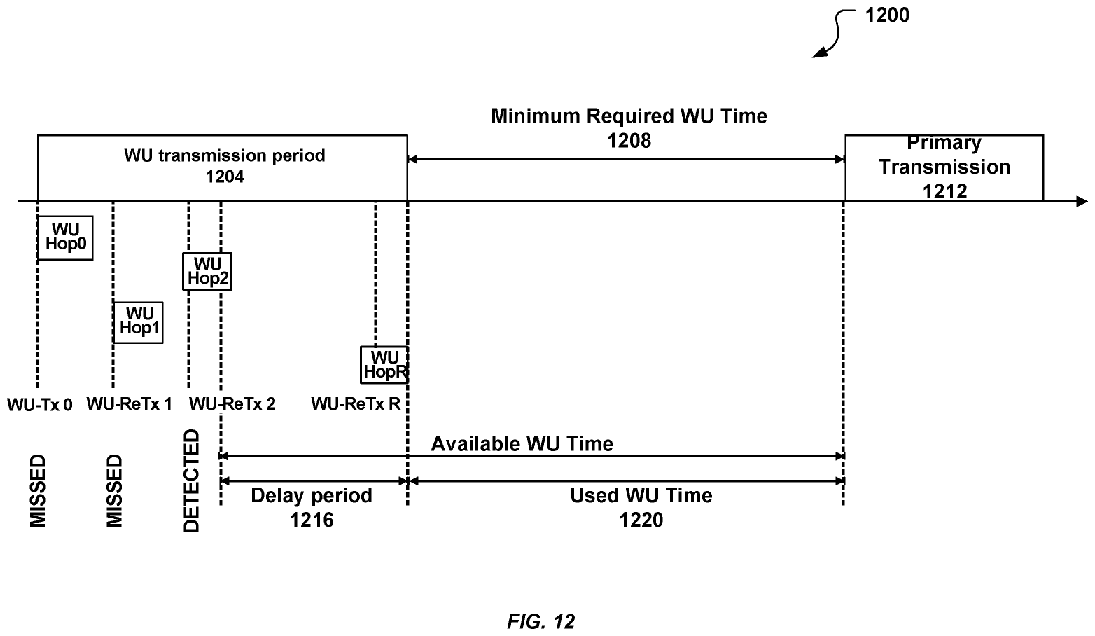

FIG. 12 illustrates a signaling sequence 1200 with repeated transmission of a wake-up signal in accordance with some embodiments.

The signaling sequence 1200 may include a number of repetitions of a wake-up signal transmission. For example, the repetitions may include an initial transmission (WU-Tx 0) and R retransmissions within a WU transmission period 1204. In some embodiments, the WU transmission period 1204 may correspond to a WU occasion.

In some embodiments, and as shown, each repetition of the wake-up signal may correspond to a respective hop in a frequency-hopping pattern. In other embodiments, repeated wake-up signal transmissions may be made without frequency hopping.

Providing both frequency hopping and repetition may provide frequency and time diversity that may increase decoding success rates by the WU receiver 116.

In some embodiments, the WU transmission period 1204 may be followed by a minimum required WU time 1208 before the network device 104 transmits the primary transmission 1212. The primary transmission 1212 may include a PDCCH transmission to schedule an uplink or downlink transmission.

If the WU receiver 116 successfully decodes the wake-up signal before the last repetition, the WU receiver 116 (or driver 120) may delay activation of the primary component radio 112 to save further power. For example, if the WU receiver 116 detects the wake-up signal in WU-ReTx 2, as shown, and immediately triggers a wake-up of the primary component radio 112, the primary component radio 112 will be wake up before necessary. Instead, the triggering of the wake-up may be delayed for a delay period 1216 so that the used WU time 1220 matches the minimum required WU time 1208.

The WU receiver 116 may determine which repetition is received based on a time of receipt within the WU transmission period 1204 or the WU signal frequency position at which the WU signal is detected. The WU receiver 116 (or driver 120) may determine a length of the delay period 1216, if any, based on which repetition is received.

Cellular networks may span a number of different frequency bands. In some embodiments, a wake-up band may be universally defined for a number of different primary systems that may be located in different frequency bands.

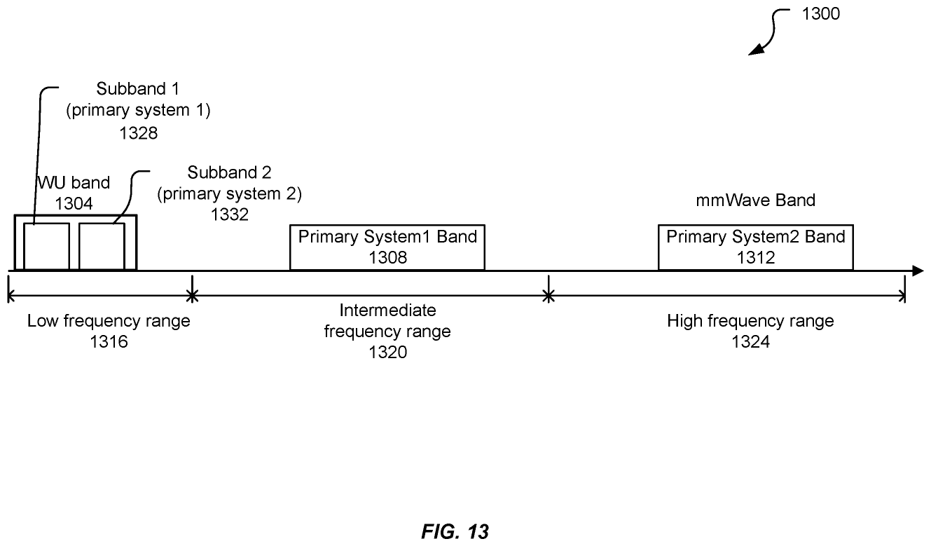

FIG. 13 illustrates a spectrum allocation 1300 in accordance with some embodiments. The spectrum allocation 1300 includes a WU band 1304, a primary system 1 band 1308, and a primary system 2 band 1312. The WU band 1304 may be located in a lower frequency range 1316, the primary system 1 band 1308 may be a mid-band located in an intermediate frequency range 1320, and the primary system 2 band 1312 may be a millimeter wave (mmWave) band be located in a high frequency range 1324.

The WU band 1304 may have subbands dedicated to specific primary systems. For example, the WU band 1304 may include a first subband 1328 for WU signals that are to be used for primary system 1 and a second subband 1332 for WU signals that are to be used for primary system 2. If, for example, the primary component radio 112 is configured to communicate via the primary communication channel in the primary system 2 band 1312, the WU receiver 116 may be configured to receive wake-up signals in the second subband 1332 of the WU band 1304.

In this manner, the band used by the WU receiver 116 is decoupled from the band used for the primary component radio 112 and can be adapted to criteria and objectives applicable to wake-up signals rather than signals of the primary communication channel. For example, the size and location of WU band 1304 may be selected for propagation characteristics desirable for wake-up signals. In some embodiments, the WU band 1304 may have 10-20 MHz of bandwidth and may be located in white-space range of Frequency Range 1, which is below 7.125 GHz.

Utilizing a common WU band for different primary systems may also simplify design of the wake-up receivers. For example, a wake-up receiver may be compatible with a wide range of devices and systems, thereby facilitating interoperability.

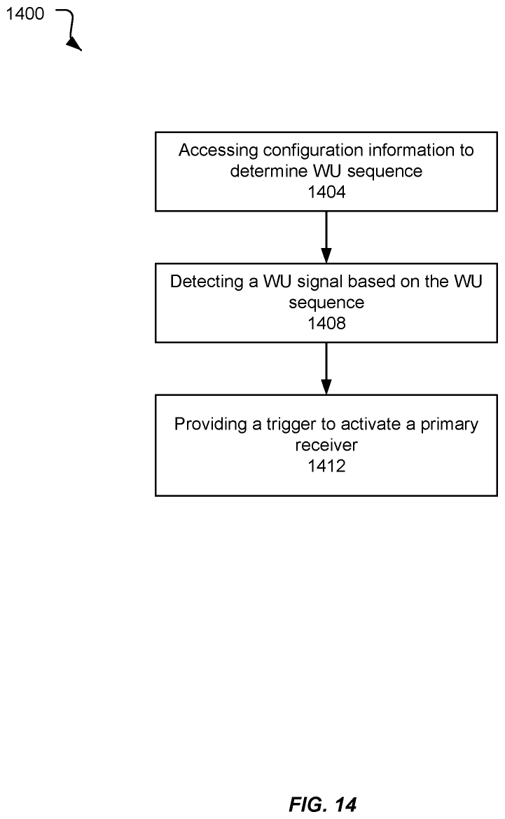

FIG. 14 may include an operation flow/algorithmic structure 1400 in accordance with some embodiments. The operation flow/algorithmic structure 1400 may be performed or implemented by a device such as, for example, UE 108, UE 412, UE 408, UE 720, UE 724 or UE 1700; or components thereof, for example, processors 1704.

The operation flow/algorithmic structure 1400 may include, at 1404, accessing configuration information to determine a WU sequence. The configuration information may be received by the UE via a primary receiver and stored in memory of the UE. The configuration information may include a variety of WU configuration parameters including, but not limited to, sequence information, offset information, codes (e.g., binary, device-specific codes or cell-specific signatures), frequency hopping patterns, and repetition information.

The WU sequence may include a plurality of tones on a respective plurality of frequencies. The tones may be distributed through corresponding tone groups. In some embodiments, the

The operation flow/algorithmic structure 1400 may further include, at 1408, detecting a WU signal based on the WU sequence. The WU signal may be detected by a dedicated WU receiver. The WU signal may be out-of-band with respect to a primary communication channel used by the primary receiver.

In embodiments in which the configuration parameters include a code, the WU sequence may be modulated (e.g., amplitude modulated) by the code to generate a modulated WU sequence. The UE may attempt to detect the WU signal based on the modulated WU sequence.

The operation flow/algorithmic structure 1400 may further include, at 1412, providing a trigger to activate a primary receiver. The trigger may be provided as soon as the WU signal is detected. Alternatively, the trigger may be delayed by an amount calculated to activate the primary receiver just before a transmission is expected via the primary communication channel.

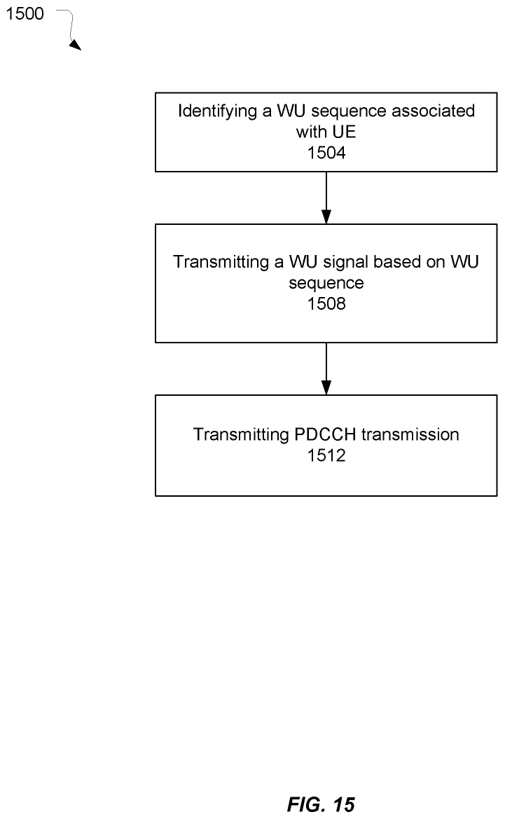

FIG. 15 may include an operation flow/algorithmic structure 1500 in accordance with some embodiments. The operation flow/algorithmic structure 1500 may be performed or implemented by a network device such as, for example, network device 104, WU transmitter 404, base station 704, base station 712, UE 1700, or base station 1800; or components thereof, for example, processors 1804.

The operation flow/algorithmic structure 1500 may include, at 1504, identifying a WU sequence associated with a UE. The wake-up sequence may include a plurality of tones on a respective plurality frequencies.

In some embodiments, the network device may transmit configuration information to the UE to configure the UE with the WU sequence and other related information. The other related information may include, for example, a code, an offset, the frequency hopping pattern, or repetition information.

In some embodiments, the network device may configure UEs with WU information based on respective signal measurements. For example, if signal measurements indicate a UE is communicating with a communication channel having a relatively poor quality, the configuration information may: configure a relatively longer WU sequence; configure a WU sequence on a set of tones that are more widely spaced; or may configure a WU sequence with frequency hopping or repetition.

The operation flow/algorithmic structure 1500 may further include, at 1508, transmitting a WU signal based on the WU sequence. The WU signal may be transmitted by the network device when the network device determines data is to be transmitted via a primary communication channel.

The operation flow/algorithmic structure 1500 may further include, at 1512, transmitting a PDCCH transmission. The PDCCH transmission may be transmitted after the wake-up signal is transmitted. In some embodiments, the UE may be in idle or inactive mode and the PDCCH transmission may include paging information that prompts the receiving UE to initiate a random-access channel (RACH) procedure to establish an RRC connection. In other embodiments, the UE may be in a connected mode and the PDCCH transmission may directly schedule uplink or downlink transmissions for a primary communication channel.

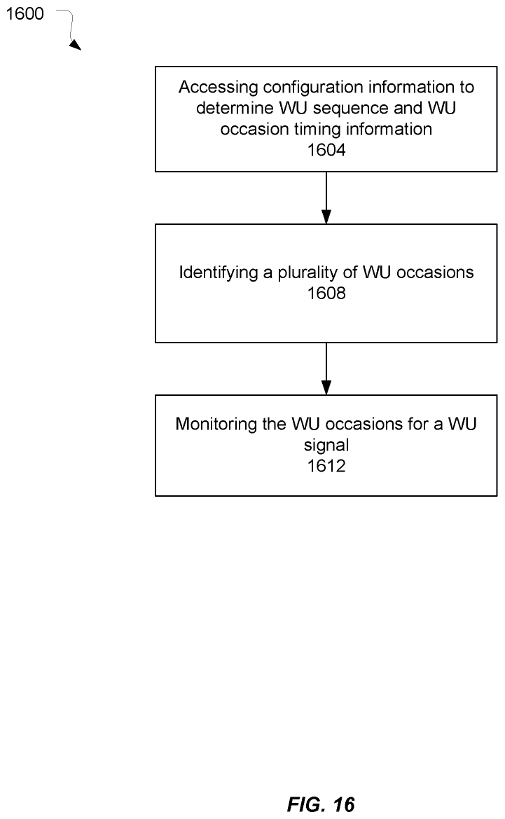

FIG. 16 may include an operation flow/algorithmic structure 1600 in accordance with some embodiments. The operation flow/algorithmic structure 1600 may be performed or implemented by a device such as, for example, UE 108, UE 412, UE 408, UE 720, UE 724 or UE 1700; or components thereof, for example, processors 1704.

The operation flow/algorithmic structure 1600 may include, at 1604, accessing configuration information to determine a WU sequence and WU occasion timing information. The WU sequence and WU occasion timing information may apply to all cells of a tracking area.

Configuration of the WU sequence may be similar to that described above and elsewhere herein. The WU occasion timing information may include a length of the WU cycle, a first number of WU frames in the WU cycle, and a second number of WU occasions in each of the first number of WU frames. The WU occasion timing information may be predefined in, for example, a 3GPP TS, or may be dynamically configured to the UE by a base station.

The operation flow/algorithmic structure 1600 may further include, at 1608, identifying a plurality of WU occasions that are to be monitored. The plurality of WU occasions to be monitored may be distributed throughout one or more WU frames in a WU cycle. The number of WU frames having a WU occasion to monitor may be based on a priority level or latency requirement of the device.

The operation flow/algorithmic structure 1600 may further include, at 1612, monitoring the WU occasions identified at 1068 for a WU signal. If a WU signal is detected by a WU receiver of the device, the WU receiver may issue a trigger to activate a primary receiver of the device.

FIG. 17 illustrates an example UE 1700 in accordance with some embodiments. The UE 1700 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 1700 may include processors 1704, RF interface circuitry 1708, memory/storage 1712, user interface 1716, sensors 1720, driver circuitry 1722, power management integrated circuit (PMIC) 1724, antenna structure 1726, and battery 1728. The components of the UE 1700 may be implemented as integrated circuits (ICs), portions thereof, discrete electronic devices, or other modules, logic, hardware, software, firmware, or a combination thereof. The block diagram of FIG. 17 is intended to show a high-level view of some of the components of the UE 1700. However, some of the components shown may be omitted, additional components may be present, and different arrangement of the components shown may occur in other implementations.

The components of the UE 1700 may be coupled with various other components over one or more interconnects 1732, which may represent any type of interface, input/output, bus (local, system, or expansion), transmission line, trace, optical connection, etc. that allows various circuit components (on common or different chips or chipsets) to interact with one another.

The processors 1704 may include processor circuitry such as, for example, baseband processor circuitry (BB) 1704A, central processor unit circuitry (CPU) 1704B, and graphics processor unit circuitry (GPU) 1704C. The processors 1704 may include any type of circuitry or processor circuitry that executes or otherwise operates computer-executable instructions, such as program code, software modules, or functional processes from memory/storage 1712 to cause the UE 1700 to perform operations as described herein.

In some embodiments, the baseband processor circuitry 1704A may access a communication protocol stack 1736 in the memory/storage 1712 to communicate over a 3GPP compatible network. In general, the baseband processor circuitry 1704A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1708.

The baseband processor circuitry 1704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1712 may include one or more non-transitory, computer-readable media that includes instructions (for example, communication protocol stack 1736) that may be executed by one or more of the processors 1704 to cause the UE 1700 to perform various operations described herein. The memory/storage 1712 include any type of volatile or non-volatile memory that may be distributed throughout the UE 1700. In some embodiments, some of the memory/storage 1712 may be located on the processors 1704 themselves (for example, L1 and L2 cache), while other memory/storage 1712 is external to the processors 1704 but accessible thereto via a memory interface. The memory/storage 1712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1708 may include transceiver circuitry and radio frequency front module (RFEM) that allows the UE 1700 to communicate with other devices over a radio access network. The RF interface circuitry 1708 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1726 and proceed to filter and amplify (with a low-noise amplifier) the signal. The signal may be provided to a receiver of the transceiver that down-converts the RF signal into a baseband signal that is provided to the baseband processor of the processors 1704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1726.

In various embodiments, the RF interface circuitry 1708 may be configured to transmit/receive signals in a manner compatible with NR access technologies.

The antenna structure 1726 may include antenna elements to convert electrical signals into radio waves to travel through the air and to convert received radio waves into electrical signals. The antenna elements may be arranged into one or more antenna panels. The antenna structure 1726 may have antenna panels that are omnidirectional, directional, or a combination thereof to enable beamforming and multiple-input, multiple-output communications. The antenna structure 1726 may include microstrip antennas, printed antennas fabricated on the surface of one or more printed circuit boards, patch antennas, phased array antennas, etc. The antenna structure 1726 may have one or more panels designed for specific frequency bands including bands in FR1 or FR2.

In some embodiments, the UE 1700 may include beamforming circuitry to be utilized for communication with the UE 1700.

The user interface circuitry 1716 includes various input/output (I/O) devices designed to enable user interaction with the UE 1700. The user interface 1716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1700.

The sensors 1720 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1722 may include software and hardware elements that operate to control particular devices that are embedded in the UE 1700, attached to the UE 1700, or otherwise communicatively coupled with the UE 1700. The driver circuitry 1722 may include individual drivers allowing other components to interact with or control various input/output (I/O) devices that may be present within, or connected to, the UE 1700. For example, driver circuitry 1722 may include a display driver to control and allow access to a display device, a touchscreen driver to control and allow access to a touchscreen interface, sensor drivers to obtain sensor readings of sensors 1720 and control and allow access to sensors 1720, drivers to obtain actuator positions of electro-mechanic components or control and allow access to the electro-mechanic components, a camera driver to control and allow access to an embedded image capture device, audio drivers to control and allow access to one or more audio devices.

The PMIC 1724 may manage power provided to various components of the UE 1700. In particular, with respect to the processors 1704, the PMIC 1724 may control power-source selection, voltage scaling, battery charging, or DC-to-DC conversion.

In some embodiments, the PMIC 1724 may control, or otherwise be part of, various power saving mechanisms of the UE 1700. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1700 may power down for brief intervals of time and thus save power. If there is no data traffic activity for an extended period of time, then the UE 1700 may transition off to an RRC_Idle state, where it disconnects from the network and does not perform operations such as channel quality feedback, handover, etc. The UE 1700 goes into a very low power state and it performs paging where again it periodically wakes up to listen to the network and then powers down again. The UE 1700 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1728 may power the UE 1700, although in some examples the UE 1700 may be mounted deployed in a fixed location, and may have a power supply coupled to an electrical grid. The battery 1728 may be a lithium ion battery, a metal-air battery, such as a zinc-air battery, an aluminum-air battery, a lithium-air battery, and the like. In some implementations, such as in vehicle-based applications, the battery 1728 may be a typical lead-acid automotive battery.

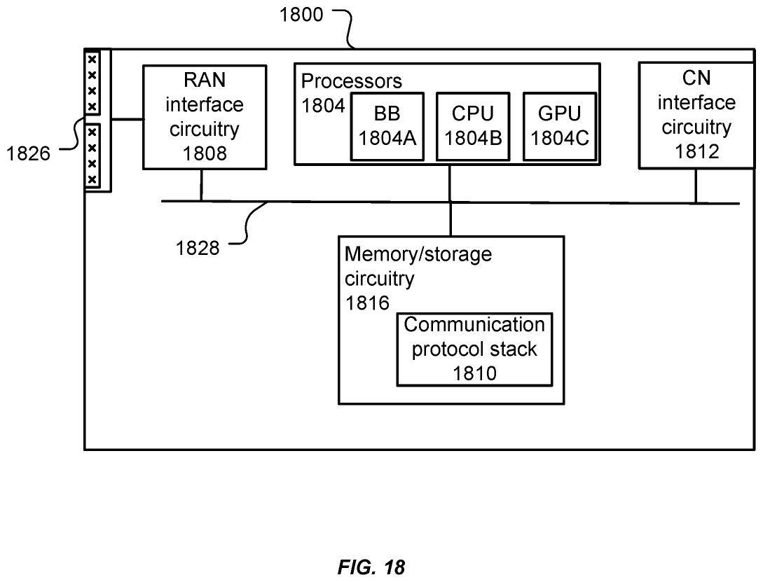

FIG. 18 illustrates an example base station 1800 in accordance with some embodiments. The base station 1800 may include processors 1804, RF interface circuitry 1808, core network (CN) interface circuitry 1812, memory/storage circuitry 1816, and antenna structure 1826.

The components of the base station 1800 may be coupled with various other components over one or more interconnects 1828.

The processors 1804, RF interface circuitry 1808, memory/storage circuitry 1816 (including communication protocol stack 1810), antenna structure 1826, and interconnects 1828 may be similar to like-named elements shown and described with respect to FIG. 17.

The CN interface circuitry 1812 may provide connectivity to a core network, for example, a 5th Generation Core network (5GC) using a 5GC-compatible network interface protocol such as carrier Ethernet protocols, or some other suitable protocol. Network connectivity may be provided to/from the base station 1800 via a fiber optic or wireless backhaul. The CN interface circuitry 1812 may include one or more dedicated processors or FPGAs to communicate using one or more of the aforementioned protocols. In some implementations, the CN interface circuitry 1812 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a device, the method comprising: accessing configuration information to determine a wake-up (WU) sequence and WU-occasion (WU-O) timing information; identifying, based on the WU-O timing information, a plurality of WU occasions; and monitoring the plurality of WU occasions for a WU signal based on the WU sequence.

Example 2 includes the method of example 1 or some other example herein, wherein the WU sequence includes a plurality of tones on a respective plurality of frequencies.

Example 3 includes method of example 1 or some other example herein, further comprising: determining, based on the WU-O timing information, a length of a WU cycle, a first number of WU frames in the WU cycle, and a second number of WU occasions in each of the first number of WU frames.

Example 4 includes a method of example 3 or some other example herein, wherein the plurality of WU occasions are distributed throughout a subset of WU frames of the first number of WU frames.

Example 5 includes the method of example 4 some other example herein, wherein the subset of WU frames includes a third number of WU frames that is associated with a priority level of the device or latency requirements of the device.

Example 6 includes the method of example 1 or some other example herein, wherein the WU sequence and the WU-O timing information apply to all cells within a tracking area.

Example 7 includes a method of example 1 or some other example herein, further comprising: monitoring a first set of frequencies in a first WU occasion of the plurality of WU occasions for the WU signal; and monitoring a second set of frequencies in a second WU occasion of the plurality of WU occasions for the WU signal.

Example 8 includes a method of operating a device, the method comprising: accessing configuration information to determine a wake-up (WU) sequence and WU-occasion (WU-O) timing information; identifying, based on the WU-O timing information, a WU occasion; and transmitting, based on the WU sequence, a WU signal to a user equipment (UE) in the WU occasion.

Example 9 includes the method of example 8 or some other example herein, wherein the WU sequence includes a plurality of tones on a respective plurality of frequencies.

Example 10 includes the method of example 9 or some other example herein, further comprising: determining, based on the WU-O timing information, a length of a WU cycle, a first number of WU frames in the WU cycle, and a second number of WU occasions in each of the first number of WU frames.

Example 11 includes the method of example 10 or some other example herein, wherein a plurality of WU occasions are distributed throughout a subset of WU frames of the first number of WU frames.

Example 12 includes the method of example 11 or some other example herein, wherein the subset of WU frames includes a third number of WU frames that is associated with a priority level of the device or latency requirements of the UE.

Example 13 includes the method of example 8 or some other example herein, further comprising: determining a frequency hopping pattern; and transmitting the WU signal based on the frequency hopping pattern.

Example 14 includes the method of example 13 or some other example herein, wherein transmitting the WU signal based on the frequency hopping pattern comprises: transmitting a first repetition of the WU signal with a first plurality of tones; and transmitting a second repetition of the WU signal with a second plurality of tones, wherein at least one tone of the second plurality of tones is not included in the first plurality of tones.

Example 15 includes the method of example 14 or some other example herein, further comprising: transmitting the first and second repetitions of the WU signal in the WU occasion.

Example 16 includes the method of example 8 or some other example herein, wherein transmitting the WU signal comprises: transmitting a plurality of repetitions of the WU signal in the WU occasion.

Example 17 includes the method of example 8 or some other example herein, further comprising: transmitting a physical downlink control channel (PDCCH) transmission in a band designated for a primary system.

Example 18 includes the method of example 17 or some other example herein, further comprising: transmitting the wake-up signal in a subset of frequencies of a WU band that is associated with the primary system, wherein the WU band is separate from the band designated for the primary system.

Example 19 includes the method of example 18 or some other example herein, wherein the primary system is a first primary system, the subset of frequencies is a first subset of frequencies, and the WU band further includes a second subset of frequencies that is associated with a second primary system.

Example 20 includes the method of example 18 or some other example herein, wherein the band designated for the primary system is above 7.125 GHz and the WU band is below 7.125 GHz.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. One or more non-transitory, computer-readable media having instructions that, when executed, cause processing circuitry to:
access configuration information to determine a wake-up (WU) sequence and WU-occasion (WU-O) timing information;
identify, based on the WU-O timing information, a plurality of WU occasions; and
monitor the plurality of WU occasions for a WU signal based on the WU sequence.

22. The one or more non-transitory, computer-readable media of claim 21, wherein the WU sequence includes a plurality of tones on a respective plurality of frequencies.

23. The one or more non-transitory, computer-readable media of claim 21, wherein the instructions, when executed, further cause the processing circuitry to:
determine, based on the WU-O timing information, a length of a WU cycle, a first number of WU frames in the WU cycle, and a second number of WU occasions in each of the first number of WU frames.

24. The one or more non-transitory, computer-readable media of claim 23, wherein the plurality of WU occasions are distributed throughout a subset of WU frames of the first number of WU frames.

25. The one or more non-transitory, computer-readable media of claim 24, wherein the subset of WU frames includes a third number of WU frames that is associated with a priority level of a device or a latency requirement of the device.

26. The one or more non-transitory, computer-readable media of claim 21, wherein the WU sequence and the WU-O timing information apply to all cells within a tracking area.

27. The one or more non-transitory, computer-readable media of claim 21, wherein the instructions, when executed, further cause the processing circuitry to:
monitor a first set of frequencies in a first WU occasion of the plurality of WU occasions for the WU signal; and
monitor a second set of frequencies in a second WU occasion of the plurality of WU occasions for the WU signal.

28. A method comprising:
accessing configuration information to determine a wake-up (WU) sequence and WU-occasion (WU-O) timing information;
identifying, based on the WU-O timing information, a WU occasion; and
generating, based on the WU sequence, a WU signal for transmission to a user equipment (UE) in the WU occasion.

29. The method of claim 28, wherein the WU sequence includes a plurality of tones on a respective plurality of frequencies.

30. The method of claim 29, further comprising:
determining, based on the WU-O timing information, a length of a WU cycle, a first number of WU frames in the WU cycle, and a second number of WU occasions in each of the first number of WU frames.

31. The method of claim 30, wherein a plurality of WU occasions are distributed throughout a subset of WU frames of the first number of WU frames.

32. The method of claim 31, wherein the subset of WU frames includes a third number of WU frames that is associated with a priority level of the UE or a latency requirement of the UE.

33. The method of claim 28, further comprising:
determining a frequency hopping pattern; and
generating the WU signal based on the frequency hopping pattern.

34. The method of claim 33, wherein transmitting the WU signal based on the frequency hopping pattern comprises:
generating a first repetition of the WU signal with a first plurality of tones; and
generating a second repetition of the WU signal with a second plurality of tones, wherein at least one tone of the second plurality of tones is not included in the first plurality of tones.

35. The method of claim 34, further comprising: transmitting the first and second repetitions of the WU signal in the WU occasion.

36. The method of claim 28, wherein generating the WU signal comprises:
generating a plurality of repetitions of the WU signal in the WU occasion.

37. The method of claim 28, further comprising:
generating a physical downlink control channel (PDCCH) transmission for transmission in a band designated for a primary system.

38. The method of claim 37, further comprising:
generating the WU signal in a subset of frequencies of a WU band that is associated with the primary system,
wherein the WU band is separate from the band designated for the primary system.

39. The method of claim 38, wherein the primary system is a first primary system, the subset of frequencies is a first subset of frequencies, and the WU band further includes a second subset of frequencies that is associated with a second primary system.

40. The method of claim 38, wherein the band designated for the primary system is above 7.125 GHz and the WU band is below 7.125 GHz.
